(19) United States
(12) Patent Application Publication
(10) Pub. No.: US 2002/0052759 A1
(43) Pub. Date: May 2, 2002

(54) Method of watching a person to be vaccinated in time and system thereof

(75) Inventor: Hui-Wen Cheng, Taipei (TW)

Correspondence Address: BACON & THOMAS, 4th Floor, 625 Slaters Lane, Alexandria, VA, 22314, US

(73) Assignee: TrustMed. Com Corp., Taipei (TW)

(21) Appl. No.: 09/782,227

(22) Filed: Feb. 14, 2001

(30) Foreign Application Priority Data
Oct. 31, 2000 (TW) 89122929

(51) Int. Cl. G06F 17/60

(52) U.S. Cl. 705/2

(57) ABSTRACT

A system of watching a person to be vaccinated in time includes a database server; a network server; and a communication devices; wherein the database server is built-in with a database of vaccination and with a software, so that a) the database server determines time for a person to be vaccinated according to medical criteria on his/her vaccination history recorded in the database; b) said network server and said communication means notify said person or his/her proxy the determined vaccination time in advance the determined vaccination time; and c) said network server and said communication means remind said person or his/her proxy of the vaccination if said network server should fail to receive a confirmation of his/her vaccination after the determined vaccination time.

### FIELD OF THE INVENTION

The present invention relates to a method and a system of watching a person to be vaccinated in time.

### BACKGROUND OF THE INVENTION

Children's vaccination should be followed up. However, the hospitals do not have an appropriate watching system. After each vaccination, a hospital can only remind the parent/guardian the time of next vaccination for a child, and is unable to notify or remind the parent/guardian when a child is due for a vaccination. Therefore, sometimes a child is not vaccinated due to the parent/guardian forgets or other factors, thereby causing a poor result in vaccination or even ineffective in vaccination.

### SUMMARY OF THE INVENTION

The present invention provides a method and a system of and watching a child to be vaccinated in time to solve the above-mentioned problems long existed in the medical field.

In one aspect of the present invention, a method of watching a child to be vaccinated in time according to the present invention is carried out via a network.

In another aspect of the present invention, a system of watching a child to be vaccinated in time according to the present invention works cooperatively with a network.

### BRIEF DESCRIPTION OF THE DRAWINGS

FIG. 1 is a flowchart showing a method of watching a child to be vaccinated in time according to a first embodiment of the present invention.

FIG. 2 is a schematic block diagram showing a system of watching a child to be vaccinated in time according to the present invention.

FIG. 3 is a flowchart showing a method of watching a child to be vaccinated in time according to a second embodiment of the present invention.

### DETAILED DESCRIPTION OF THE INVENTION

The present invention discloses a method of watching a child to be vaccinated in time comprising the following steps carried out in a computer system:

a) determining time for a person to be vaccinated according to medical criteria on his/her vaccination history recorded in a database of vaccination of persons;

b) notifying said person or his/her proxy the determined vaccination time in advance the determined vaccination time;

c) reminding said person or his/her proxy of the vaccination if said computer system should fail to receive a confirmation of his/her vaccination after the determined vaccination time; and

d) entering vaccination data of said person into the database of vaccination of persons, if said computer system receives the confirmation of his/her vaccination.

Preferably, said database of vaccination contains data related to Hepatitis B vaccine; Diphtheria, tetanus toxoids and pertussis mixed vaccine; Poliovirus vaccine; or Japanese encephalitis vaccine.

Preferably, said medical criteria are vaccination timetable recognized by the medical profession.

Preferably, said reminding is once per day.

Preferably, said notifying or said reminding step adopt a WAP system.

The database of vaccination is preferably set up before the method of the present invention is implemented; however, it can also be set up when the method of the present invention is initiated.

The database of vaccination contains data of a child or a person that should be recorded by a medical practitioner, e.g. name (or ID number, such as citizen's ID number, number of registration card of a hospital), data of vaccination, etc.

The medical criteria for determining the time for a child to be vaccinated can also be a doctor's subjective judgement, or according to the vaccination timetable recognized by the medical profession with the doctor's adjustment.

A typical child's vaccination timetable for Hepatitis B vaccine, Diphtheria, tetanus toxoids and pertussis mixed vaccine; Poliovirus vaccine; or Japanese encephalitis vaccine recognized by the medical profession can be programmed as follows: The following four options will appear when a computer program is executed:

Hepatitis B vaccine

Diphtheria, tetanus toxoids and pertussis mixed vaccine

Poliovirus vaccine

Japanese encephalitis vaccine

I. Select the “Hepatitis B vaccine” option, the following options will appear:

First dose;

Second dose;

Third dose;

Fourth dose.

1) Select the “first dose” option, then (a) the following messages will appear “injection in the first week after birth”, and “Please enter the date of injection of the first dose” (default being the current date); (b) schedule date of injection of the second dose (automatic calculation: date of injection of the first dose plus four weeks), schedule date of injection of the third dose (automatic calculation: date of injection of the second dose plus four weeks), and schedule date of injection of the fourth dose (automatic calculation: date of injection of the third dose plus 43 weeks), when “the date of injection of the first dose” is entered and sent; and (c) notify the schedule dates through e-mail or a Wireless Application Protocol (WAP) system.

2) Select the “second dose” option, then (a) the following messages will appear “injection in the fifth week after birth”, and “Please enter the date of injection of the second dose”; (b) schedule date of injection of the third dose (automatic calculation: date of injection of the second dose plus four weeks), and schedule date of injection of the fourth dose (automatic calculation: date of injection of the third dose plus 43 weeks), when “the date of injection of the second dose” is entered and sent; and (c) notify the schedule dates through e-mail or a Wireless Application Protocol (WAP) system.

3) Select the “third dose” option, then (a) the following messages will appear “injection in the ninth week after birth”, and “Please enter the date of injection of the third dose”; (b) schedule date of injection of the fourth dose (automatic calculation: date of injection of the third dose plus 43 weeks), when “the date of injection of the third dose” is entered and sent; and (c) notify the schedule date through e-mail or a Wireless Application Protocol (WAP) system.

4) Select the “fourth dose” option, then (a) the following messages will appear “injection in the twelfth month after birth”, and “Please enter the date of injection of the fourth dose”.

II. Select the “Diphtheria, tetanus toxoids and pertussis mixed vaccine” option, the following options will appear:

First dose;

Second dose;

Third dose;

1) Select the “first dose” option, then (a) the following messages will appear “injection two months after birth”, and “Please enter the date of injection of the first dose”; (b) schedule date of injection of the second dose (automatic calculation: date of injection of the first dose plus two months), and schedule date of injection of the third dose (automatic calculation: date of injection of the second dose plus two months), when “the date of injection of the first dose” is entered and sent; and (c) notify the schedule dates through e-mail or a Wireless Application Protocol (WAP) system.

2) Select the “second dose” option, then (a) the following messages will appear “injection fourth months after birth”, and “Please enter the date of injection of the second dose”; (b) schedule date of injection of the third dose (automatic calculation: date of injection of the second dose plus two months), when “the date of injection of the second dose” is entered and sent; and (c) notify the schedule date through e-mail or a Wireless Application Protocol (WAP) system.

3) Select the “third dose” option, then (a) the following messages will appear “injection six months after birth and an additional injection one year after the third dose”, and “Please enter the date of injection of the third dose” (b) schedule date of injection of the additional dose (automatic calculation: date of injection of the third dose plus twelve months), when “the date of injection of the third dose” is entered and sent; and (c) notify the schedule date through e-mail or a Wireless Application Protocol (WAP) system. III. Select the “poliovirus vaccine” option, the following options will appear:

First dose;

Second dose;

Third dose;

1) Select the “first dose” option, then (a) the following messages will appear “injection two months after birth”, and “Please enter the date of injection of the first dose”; (b) schedule date of injection of the second dose (automatic calculation: date of injection of the first dose plus two months), and schedule date of injection of the third dose (automatic calculation: date of injection of the second dose plus two months), when “the date of injection of the first dose” is entered and sent; and (c) notify the schedule dates through e-mail or a Wireless Application Protocol (WAP) system.

2) Select the “second dose” option, then (a) the following messages will appear “injection fourth months after birth”, and “Please enter the date of injection of the second dose”; (b) schedule date of injection of the third dose (automatic calculation: date of injection of the second dose plus two months), when “the date of injection of the second dose” is entered and sent; and (c) notify the schedule date through e-mail or a Wireless Application Protocol (WAP) system.

3) Select the “third dose” option, then (a) the following messages will appear “injection six months after birth, another injection one year after the third dose, and a further injection in the first grade of the elemental school”, and “Please enter the date of injection of the third dose” (b) schedule date of the another injection (automatic calculation: date of injection of the third dose plus twelve months), and schedule date of the further injection, when “the date of injection of the third dose” is entered and sent; and (c) notify the schedule date through e-mail or a Wireless Application Protocol (WAP) system.

IV. Select the “Japanese encephalitis vaccine” option, the following options will appear:

First dose;

Second dose;

Third dose;

1) Select the “first dose” option, then (a) the following messages will appear “injection 15 months after birth”, and “Please enter the date of injection of the first dose”; (b) schedule date of injection of the second dose (automatic calculation: date of injection of the first dose plus two weeks), and schedule date of injection of the third dose (automatic calculation: date of injection of the second dose plus 12 months), when “the date of injection of the first dose” is entered and sent; and (c) notify the schedule dates through e-mail or a Wireless Application Protocol (WAP) system.

2) Select the “second dose” option, then (a) the following messages will appear “injection 15 months and two weeks after birth”, and “Please enter the date of injection of the second dose”; (b) schedule date of injection of the third dose (automatic calculation: date of injection of the second dose plus 12 months), when “the date of injection of the second dose” is entered and sent; and (c) notify the schedule date through e-mail or a Wireless Application Protocol (WAP) system.

3) Select the “third dose” option, then (a) the following messages will appear “injection 27 months and two weeks after birth and an additional injection in the first grade of the elemental school”, and “Please enter the date of injection of the third dose” (b) schedule date of injection of the additional injection, when “the date of injection of the third dose” is entered and sent; and (c) notify the schedule date through e-mail or a Wireless Application Protocol (WAP) system.

The above-mentioned notification or reminder can be carried out by using any known methods of notification or reminder, such as notification/reminder by a conventional telephone, notification/reminder through a network (e.g. e-mail, mobile phone, cable telephone, etc.) Preferably, the notification/reminder is carried out through a network. More preferably, the notification/reminder is carried out by using a mobile phone through a network. Most preferably, the notification/reminder is carried out by a mobile phone system using WAP (Wireless Application Protocol).

The above-mentioned reminder is based on whether a confirmation of a child's vaccination is received within a certain period of time after receiving a notification (or a previous reminder). Of course, the number of times of reminding can also be set to a default value, e.g. stop reminding after a specified number of reminders.

Other data related to vaccination, e.g. changes of physical conditions of a vaccinated child and other diseases, can also be simultaneously recorded in the database.

The term “in advance” varies according to the need. For example, a child reserving a clinical visit requires only slightly earlier (a few days or even earlier that day); a child without a reservation requires a much earlier notification for the child to register or make a reservation.

The present invention also discloses a system of watching a person to be vaccinated in time comprising:

a database server;

a network server; and

communication means;

wherein said database server is built-in with a database of vaccination and with a software, so that

A) said database server determines time for a person to be vaccinated according to medical criteria on his/her vaccination history recorded in said database;

B) said network server and said communication means notify said person or his/her proxy the determined vaccination time in advance the determined vaccination time; and

C) said network server and said communication means remind said person or his/her proxy of the vaccination if said network server should fail to receive a confirmation of his/her vaccination after the determined vaccination time.

The database server used in the system of the present invention can be any known database servers.

The network server can be any known network servers, and said communication means can adopt any known communication means, preferably wireless communication means, more preferably a WAP system.

Said determination can be a regular determination or a random determination. Preferably, the determination is carried out after each recordal of the latest vaccination in order to save the time spent on the determination.

The content of notification can be a simple date of vaccination, or can be added with other contents, such as common sense/knowledge/information related to vaccination.

The method and the system of watching a person to be vaccinated in time according to the present invention is not limited to be used by a hospital, and can be used by a medical research organization or an organization in the medical profession having a power of public reputation, and/or a subsidiary thereof.

In order to further elaborate the present invention, preferred embodiments are illustrated together with figures. However, the scope of the present invention is not limited by the preferred embodiments or figures.

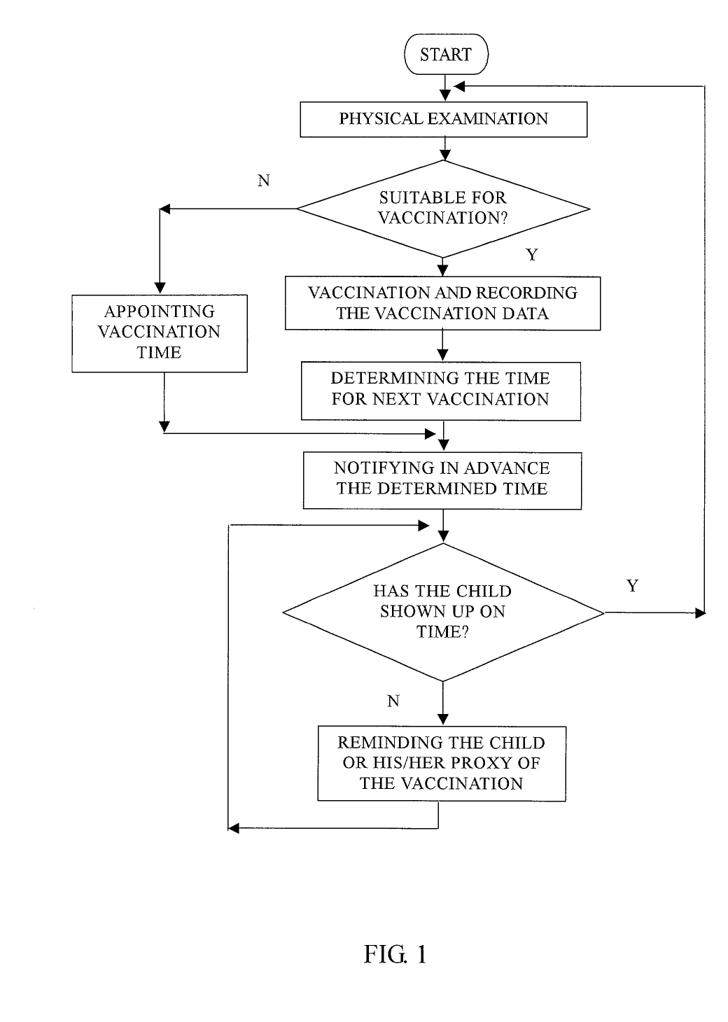

FIG. 1 is a schematic flowchart of a method of watching a person to be vaccinated in time implemented in a hospital. The method comprises physical examining a child; determining whether the child is suitable to be vaccinated; appointing vaccination time for said child, if the answer is “NO”; vaccinating the child, if the answer is “YES”; recording the data of vaccination; determining the time for next vaccination; notifying the child or his/her proxy in advance the determined time; checking whether the child has shown up according to the determined time; reminding the child or his/her proxy to be vaccinated, if the answer is “No”; and returning to the first step, if the answer is “YES”.

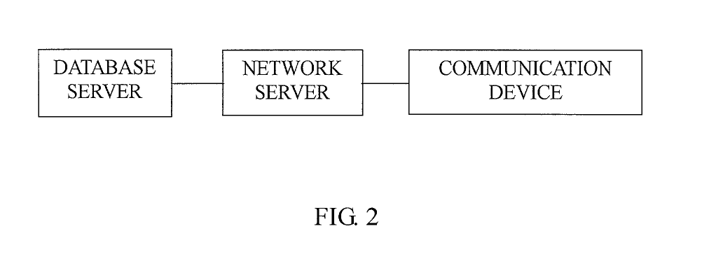

FIG. 2 is a block diagram of a system of watching a person to be vaccinated in time for use in a hospital, in which the database server uses a computer and a UNIX system, the network server uses a computer and a UNIX system, and the communication device uses a WAP system. The database server and the communication device are connected to the network server.

A new child only needs to enter the required data to the database of vaccination before, after or at the time of measuring the vaccination.

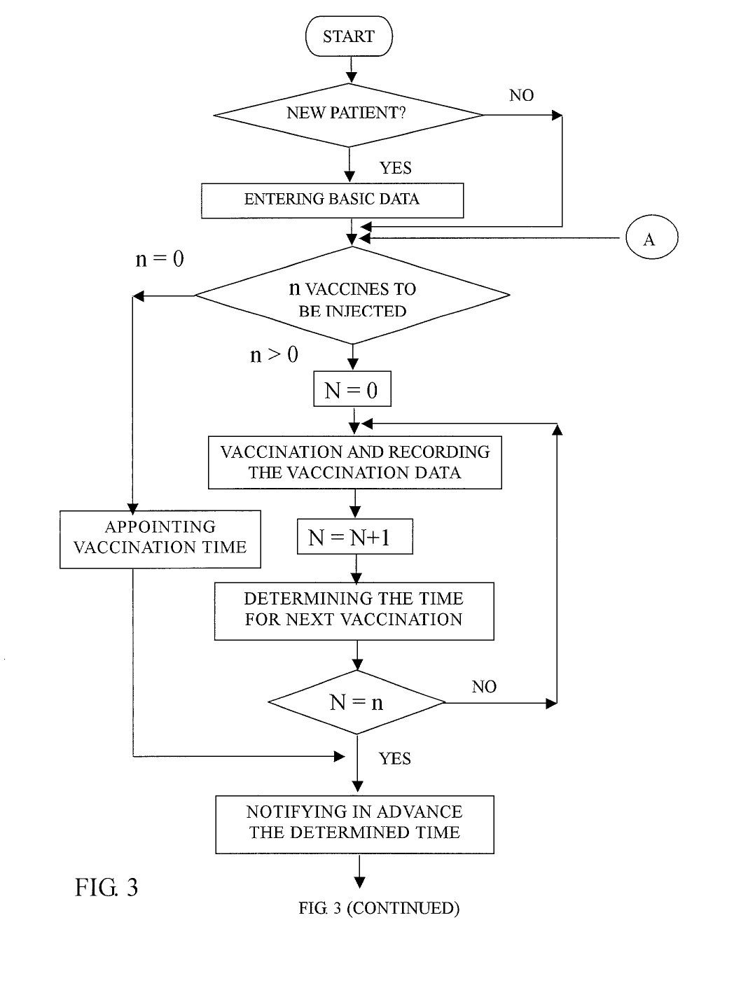

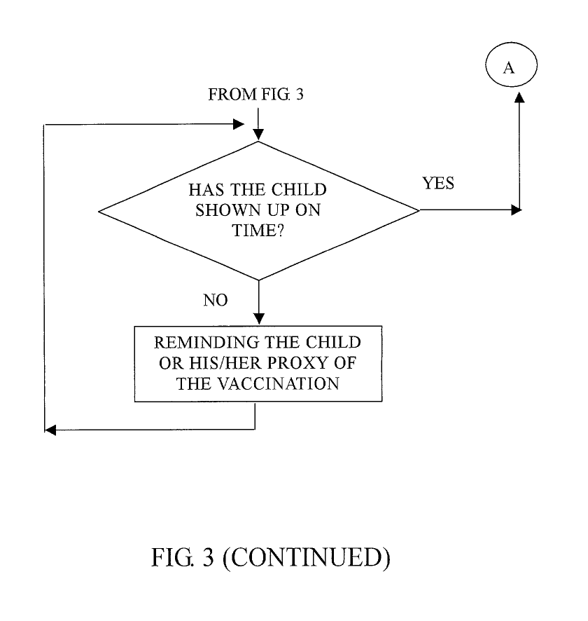

In another embodiment, the method of the present invention includes setting up the database for new children. As shown in FIG. 3, the method of this embodiment first decides whether a child receiving a physical examination is a new client (child) or not. A new child is required to enter the basic data before deciding how many kinds of vaccines are to be injected (deciding “n”, n is zero or positive integer). Each of the “n” vaccinations is then injected and recorded, and the time for next vaccination thereof is determined in sequence, until all the “n” vaccinations are injected. The steps thereafter comprises notifying the child or his/her proxy in advance the determined time; checking whether the child has shown up according to the determined time; reminding the child or his/her proxy to be vaccinated, if the answer is “No”; and returning to the step of determining “n”, if the answer is “YES”.

What is claimed is:

1. A method of watching a person to be vaccinated in time comprising the following steps carried out in a computer system:
a) determining time for a person to be vaccinated according to medical criteria on his/her vaccination history recorded in a database of vaccination of persons;
b) notifying said person or his/her proxy the determined vaccination time in advance the determined vaccination time;
c) reminding said person or his/her proxy of the vaccination if said computer system should fail to receive a confirmation of his/her vaccination after the determined vaccination time; and
d) entering vaccination data of said person into the database of vaccination of persons, if said computer system receives the confirmation of his/her vaccination.

2. The method as claimed in claim 1, in which said database of vaccination contains data related to Hepatitis B vaccine; Diphtheria, tetanus toxoids and pertussis mixed vaccine; Poliovirus vaccine; or Japanese encephalitis vaccine.

3. The method as claimed in claim 1, in which said medical criteria in step a) are vaccination timetable recognized by the medical profession.

4. The method as claimed in claim 1, in which said reminding is once per day.

5. The method as claimed in claim 1, in which said notifying or said reminding step adopt a WAP system.

6. A system of watching a person to be vaccinated in time comprising:
a database server;
a network server; and
communication means;
wherein said database server is built-in with a database of vaccination and with a software, so that
A) said database server determines time for a person to be vaccinated according to medical criteria on his/her vaccination history recorded in said database;
B) said network server and said communication means notify said person or his/her proxy the determined vaccination time in advance the determined vaccination time; and
C) said network server and said communication means remind said person or his/her proxy of the vaccination if said network server should fail to receive a confirmation of his/her vaccination after the determined vaccination time.

7. The system as claimed in claim 6, in which in which said database of vaccination contains data related to Hepatitis B vaccine; Diphtheria, tetanus toxoids and pertussis mixed vaccine; Poliovirus vaccine; or Japanese encephalitis vaccine.

8. The system as claimed in claim 6, in which said medical criteria in step a) are vaccination timetable recognized by the medical profession.

9. The system as claimed in claim 6, in which said communication means comprises a WAP system.
